(19) United States
(12) Patent Application Publication
(10) Pub. No.: US 2015/0296439 A1
(43) Pub. Date: Oct. 15, 2015

(54) DISTRIBUTED NEIGBORING CELL ASSISTED NEIGHBOUR DISCOVERY

(71) Applicant: QUALCOMM Incorporated, San Diego, CA (US)

(72) Inventors: Cong Shen, San Diego, CA (US); Vinay Joseph, San Diego, CA (US)

(73) Assignee: QUALCOMM Incorporated, San Diego, CA (US)

(21) Appl. No.: 14/249,190

(22) Filed: Apr. 9, 2014

(51) Int. Cl. H04W 40/24; H04W 48/16

(52) U.S. Cl. CPC H04W 40/246; H04W 48/16

(57) ABSTRACT

A system for distributed network-assisted neighbor discovery is operable by a network entity that performs a network discovery action to discover a plurality of neighboring cells to be neighbors of each other. The network entity informs at least one of the plurality of neighboring cells of a neighbor relationship with the plurality of neighboring cells, in response to determining the plurality of neighboring cells to be neighbors of each other.

### BACKGROUND

This application is directed to wireless communications systems, and more particularly to methods and apparatuses for distributed neighboring cell assisted neighbor discovery.

A wireless network may be deployed over a defined geographical area to provide various types of services (e.g., voice, data, multimedia services, etc.) to users within that geographical area. The wireless communication network may include a number of base stations that can support communication for a number of user equipments (UEs). A UE may communicate with a base station via the downlink and uplink.

The 3rd Generation Partnership Project (3GPP) Long Term Evolution (LTE) advanced cellular technology is an evolution of Global System for Mobile communications (GSM) and Universal Mobile Telecommunications System (UMTS). The LTE physical layer (PHY) provides a highly efficient way to convey both data and control information between base stations, such as eNBs, and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

Neighbor Relations (NRs) keep track of which cells are located near which other cells. According to 3GPP specifications, the purpose of Automatic Neighbor Relation (ANR) functionality is to relieve operators from the burden of manually managing NRs. ANR automates the process of creating and updating neighbor cell relationships for handover purposes.

An eNB manages a neighbor Relation Table (NRT). The eNB finds new neighbors and adds them to the NRT. An existing NR from the eNB to a neighboring cell means that the eNB knows a Cell Global Identifier (CGI) and a Physical Cell Identifier (PCI) of the neighboring cell and has an entry in the NRT identifying the neighboring cell.

Two common types of ANR include Network Listen (NL) assisted neighbor discovery and UE assisted neighbor discovery. In NL assisted neighbor discovery, an eNB detects neighboring cells using network listen. In UE assisted neighbor discovery, an eNB receives UE measurement reports to discover neighboring cells.

Discovering neighboring cells using current methods expends considerable network resources. In this context, there remains a need for improved techniques for distributed neighboring cell assisted neighbor discovery.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In accordance with one or more aspects of the examples described herein, there is provided a system and method for distributed network-assisted neighbor discovery. In one example, a network entity may perform a network discovery action to discover a plurality of neighboring cells to be neighbors of each other. The network entity may inform at least one of the plurality of neighboring cells of a neighbor relationship with the plurality of neighboring cells, in response to determining the plurality of neighboring cells to be neighbors of each other.

In a first related aspect, performing the network discovery action may include instructing at least one access terminal to send at least one measurement report. The network discovery action may also include determining the plurality of neighboring cells to be neighbors of each other, in response to receiving at least one of a single measurement report from an access terminal that contains identifiers for the plurality of neighboring cells, or a plurality of measurement reports from the access terminal within a time window that contain identifiers for the plurality of neighboring cells.

In a second related aspect, performing the network discovery action may include performing a NL operation on at least one frequency and determining that the plurality of neighboring cells to be neighbors of each other, based on the NL operation.

### BRIEF DESCRIPTION OF THE DRAWINGS

These and other sample aspects of the disclosure will be described in the detailed description and the appended claims that follow, and in the accompanying drawings, wherein:

FIG. 1A shows an illustration of an example wireless communication network;

FIG. 1B shows an example wireless communication system for distributed neighboring cell assisted neighbor discovery;

FIG. 1C shows a second example wireless communication system for distributed neighboring cell assisted neighbor discovery;

FIG. 1D shows a block diagram of an example wireless communication system for distributed neighboring cell assisted neighbor discovery;

FIG. 2 shows a block diagram of example communication system components;

FIG. 3 illustrates an example of a methodology for distributed neighboring cell assisted neighbor discovery;

FIG. 4 shows an example of an apparatus for distributed neighboring cell assisted neighbor discovery in accordance with the methodology of FIG. 3.

### DETAILED DESCRIPTION

Techniques for distributed neighboring cell assisted neighbor discovery are described herein. The subject disclosure provides methods and apparatuses for improving network discovery efficiency by using a first base station to gather neighborhood information. The base station deduces from particular circumstances in the gathered neighborhood information that two or more other neighboring base stations are neighbors of each other. The base station reports the neighborhood relationship to the neighboring base stations. This action saves the other base stations from expending resources individually discovering that they are neighbors of each other.

In the subject disclosure, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The techniques may be used for various wireless communication networks such as wireless wide area networks (WWANs) and wireless local area networks (WLANs). The terms “network” and “system” are often used interchangeably. The WWANs may be code division multiple access (CDMA), time division multiple access (TDMA), frequency division multiple access (FDMA), orthogonal frequency-division multiple access (OFDMA), single carrier frequency division multiple access (SC-FDMA) and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

As used herein, the downlink (or forward link) refers to the communication link from the base station to the UE, and the uplink (or reverse link) refers to the communication link from the UE to the base station. A base station may be, or may include, a macrocell or microcell. Microcells (e.g., picocells, femtocells, home nodeBs, and small cells) are characterized by having generally much lower transmit power than macrocells, and may often be deployed without central planning. In contrast, macrocells are typically installed at fixed locations as part of a planned network infrastructure, and cover relatively large areas.

The techniques described herein may be used for the wireless networks and radio technologies mentioned above as well as other wireless networks and radio technologies. For clarity, certain aspects of the techniques are described below for 3GPP network and WLAN, and LTE and WLAN terminology is used in much of the description below.

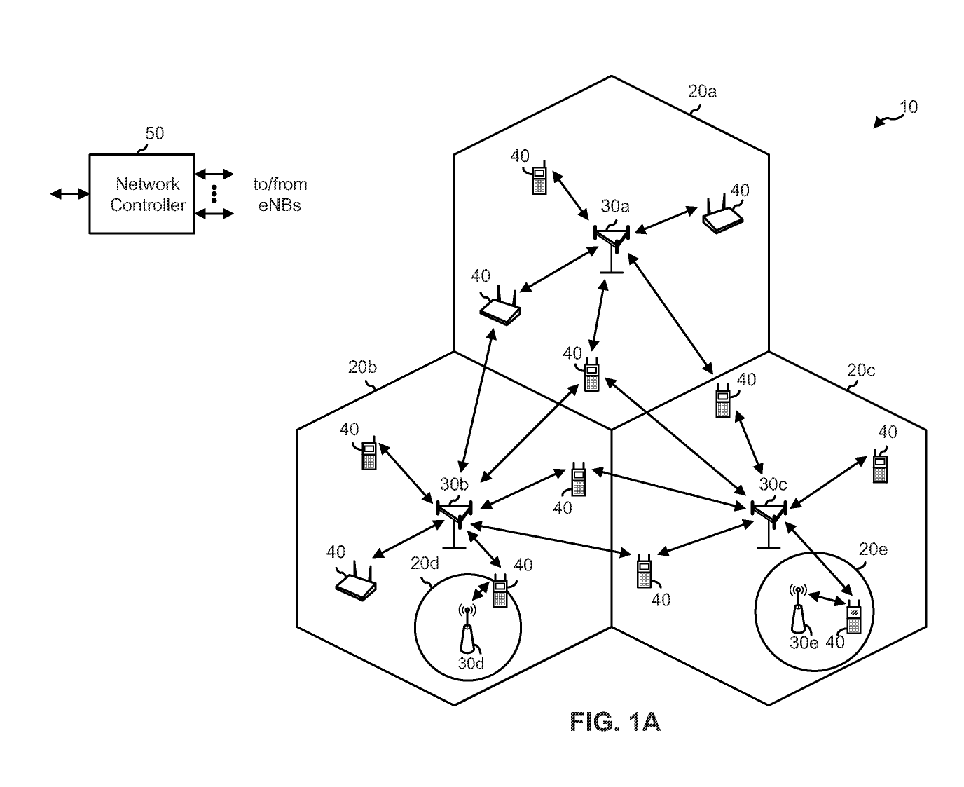

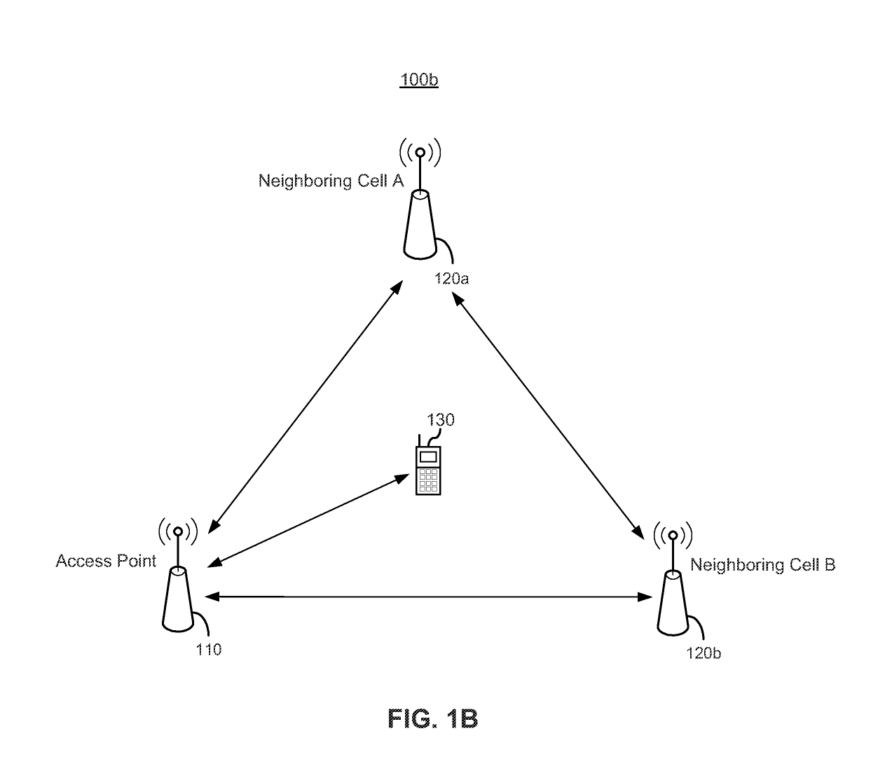

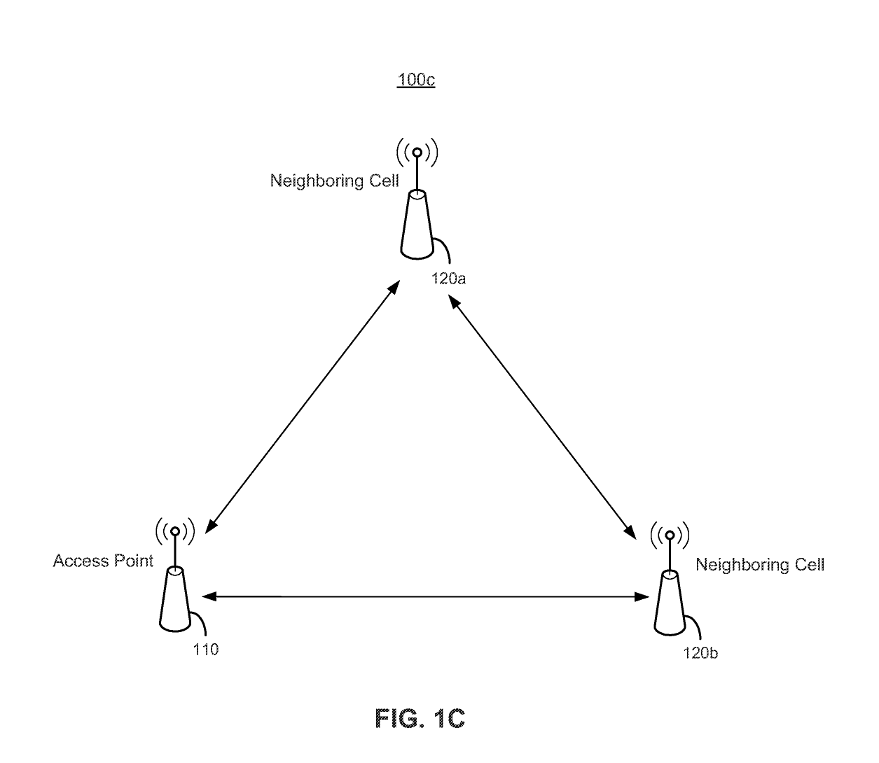

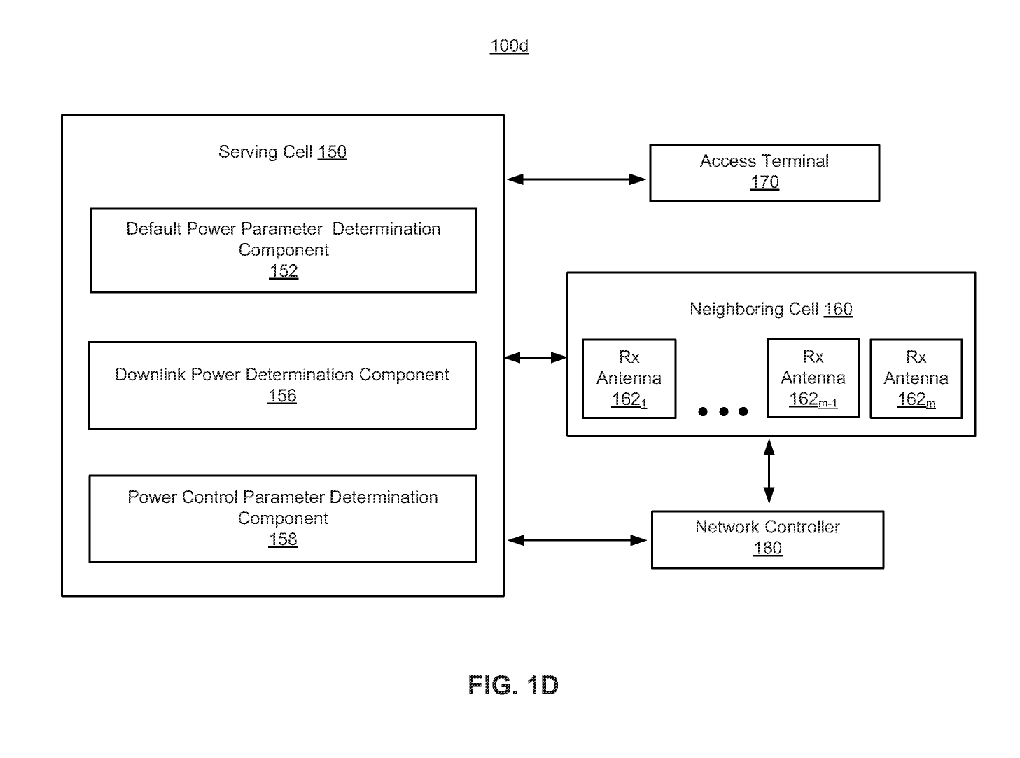

FIG. 1A is an illustration of an example wireless communication network 10, which may be an LTE network or some other wireless network. Wireless network 10 may include a number of eNBs 30 and other network entities. An eNB may be an entity that communicates with mobile entities and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macrocell, a small cell, a picocell, a microcell, a femtocell, or other types of cell. A macrocell may cover a relatively large geographic area (e.g., several kilometers in radius) and may allow unrestricted access by UEs with service subscription. A picocell may cover a relatively small geographic area and may allow unrestricted access by UEs with service subscription. A small cell may cover a relatively small geographic area (e.g., a home) and may allow restricted access by UEs having association with the small cell (e.g., UEs in a Closed Subscriber Group (CSG)). In the example shown in FIG. 1A, eNBs 30a, 30b, and 30c may be macro eNBs for macrocell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a small cell eNB, a small cell base station, or a small cell access point for a small cell 20e.

Wireless network 10 may also include relays (not shown in FIG. 1A). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may be a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, etc. A UE may also be able to communicate peer-to-peer (P2P) with other UEs.

Wireless network 10 may support operation on a single carrier or multiple carriers for each of the downlink (DL) and uplink (UL). A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the DL carrier.

Carrier aggregation allows expansion of effective bandwidth delivered to a user terminal through concurrent use of radio resources across multiple carriers. When carriers are aggregated, each carrier is referred to as a component carrier. Multiple component carriers are aggregated to form a larger overall transmission bandwidth. Two or more component carriers can be aggregated to support wider transmission bandwidths.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), or MIMO. For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

FIG. 1B shows an example wireless communication system 100b for distributed neighboring cell assisted neighbor discovery with an access point 110, a neighboring cell A 120a, a neighboring cell B 120b, and an access terminal 130. For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various examples access points may be referred to or implemented as base stations, NodeBs, eNodeBs, small cells, picocells, macrocells, and so on, while access terminals may be referred to or implemented as user equipment (UEs), mobile stations, and so on. It should also be appreciated that system 100, the serving cell 110, the neighboring cells 120a and 120b, and the access terminal 130 can include additional components not shown in FIG. 1B.

The access point 110 or neighboring cells 120a and 120b in the system 100 may each provide access to one or more services (e.g., network connectivity) for one or more wireless terminals 130 (e.g., access terminal, UE, mobile entity, mobile device). For example, a LTE access point may communicate with one or more network entities (not shown) to facilitate wide area network connectivity. Such network entities may take various forms such as, for example, one or more radio and/or core network entities.

In various examples, the network entities may be responsible for or otherwise be involved with handling: network management (e.g., via an operation, administration, management, and provisioning entity), call control, session management, mobility management, gateway functions, interworking functions, or some other suitable network functionality. In a related aspect, mobility management may relate to or involve: keeping track of the current location of access terminals through the use of tracking areas, location areas, routing areas, or some other suitable technique; controlling paging for access terminals; and providing access control for access terminals. Also, two of more of these network entities may be co-located and/or two or more of such network entities may be distributed throughout a network.

The access point 110 may be an eNB serving access terminal 130 by providing one or more services. For example, the access point 100 may be a macrocell serving a large geographic area or a small cell serving a smaller geographic area. Similarly, the neighboring cells 120a and 120b may be eNBs serving one or more access terminals by providing one or more services.

The access point 110 may communicate with the neighboring cell A 120a and neighboring cell B 120b via a backhaul. Such communication via the backhaul is known in the art such as in US Patent Application Publication No. 20120106370. In an example implementation, the access point 110 may communicate with the neighboring cell A 120a and neighboring cell B 120b using X2 messages over a X2 interface. In another example implementation, the access point 110 may communicate with the neighboring cell A 120a and neighboring cell B 120b using wireless signals.

The access point 110 may instruct the access terminal 130 to send at least one measurement report. The access terminal 130 may perform measurements to detect the presence of nearby access points and obtain identifiers of the detected access points. These measurements may be performed periodically or upon request by the access point 110. It should be appreciated, however, that in one aspect, the teachings herein do not require acquiring neighbor relation information by determining a state of the access terminal 130.

In one example, the access terminal 130 may detect two different neighboring cells 120a and 120b located near the access terminal 130. The access terminal 130 may then send a measurement report to the access point 110 including identifiers for the neighboring cell A 120a and the neighboring cell B 120b. In response to receiving the measurement report, the access point 110 may deduce not only that the neighboring cell A 120a and the neighboring cell B 120b are neighbors of the access point 110, but are also neighbors of each other.

In another example, the access terminal 130 may detect more than two different neighboring cells (not shown in FIG. 1B) and send a measurement report to the access point 110 including identifiers for the detected neighboring cells. In response to receiving the measurement report, the access point 110 may deduce that all the detected neighboring cells are neighbors of each other.

In another example, the access terminal 130 may first detect the neighboring cell A 120a and send a first measurement report to the access point 110 including only the identifier for the neighboring cell A 120a. The access terminal 130 shortly after detecting the neighboring cell B 120b may send a second measurement report to the access point 110 including only the identifier for the neighboring cell B 120b. Here, a time that passed between receiving the first measurement report and the second measurement report may be within a time window. In an example implementation, the time window may be predetermined by the access terminal or by another network entity such as an operations administration and management (OAM) entity. In response to receiving the measurement reports, the access point 110 may deduce not only that the neighboring cell A 120a and the neighboring cell B 120b are neighbors of the access point 110, but are also neighbors of each other.

In another example, the access terminal 130 may detect more than two different neighboring cells (not shown in FIG. 1B) and sends additional measurement reports corresponding to the additional detected neighboring cells. In response to receiving the measurement reports within the time window, the access point 110 may deduce that all the detected neighboring cells are neighbors of each other.

In response to determining that the neighboring cell A 120a and the neighboring cell B 120b are neighbors of each other, the access point 110 may inform one or both the neighboring cells 120 of their neighbor relationship. In an example implementation, the access point 110 may inform by sending a backhaul message to one or both the neighboring cells 120. The backhaul message may be an X2 message. In another example implementation, the access point 110 may inform by sending a message to an OAM entity, which in turn informs at least one of the neighboring cells 120a and 120b.

FIG. 1C shows a second example wireless communication system 100c for distributed neighboring cell assisted neighbor discovery with an access point 110, a neighboring cell A 120a, and a neighboring cell B 120b. It should also be appreciated that system 100, the serving cell 110, and the neighboring cells 120a and 120b can include additional components not shown in FIG. 1C.

The access point 110 may be an eNB serving access terminals (not shown in FIG. 1C) by providing one or more services. For example, the access point 100 may be a macrocell serving a large geographic area or a small cell serving a smaller geographic area. Similarly, the neighboring cells 120a and 120b may be eNBs serving one or more access terminals by providing one or more services.

The access point 110 may communicate with the neighboring cell A 120a and neighboring cell B 120b via a backhaul. In an example implementation, the access point 110 may communicate with the neighboring cell A 120a and neighboring cell B 120b using X2 messages over a X2 interface. In another example implementation, the access point 110 may communicate with the neighboring cell A 120a and neighboring cell B 120b using wireless signals.

The access point 110 may perform a network listen (NL) operation on at least one frequency. To perform the NL operation, the access point 110 may measure downlink signals transmitted from other cells such as the neighboring cells 120a and 120b. The access point 110 may discover through the NL operation that the access point 110 is neighboring the neighboring cell A 120a and the neighboring cell 120b.

In response to discovery of the neighboring cells 120, the access point 110 may deduce not only that the neighboring cell A 120a and the neighboring cell B 120b are neighbors of the access point 110, but are also neighbors of each other.

In response to determining that the neighboring cell A 120a and the neighboring cell B 120b are neighbors of each other, the access point 110 may inform one or both the neighboring cells 120 of their neighbor relationship. In an example implementation, the access point 110 may inform by sending a backhaul message to one or both the neighboring cells 120. The backhaul message may be an X2 message. In another example implementation, the access point 110 may inform by sending a message to an OAM entity, which in turn informs at least one of the neighboring cells 120a and 120b. This information sharing improves efficiency by saving the neighboring cells 120a and and 120b from expending resources individually discovering that they are neighbors of each other.

FIG. 1D shows a block diagram of an example wireless communication system 100d for distributed neighboring cell assisted neighbor discovery. A access point 150 may provide wireless services to an access terminal 170. The access point 150 may be located near a neighboring cell A 160a and a neighboring cell B 160b. The access point may communicate with a network controller 180 via backhaul.

The access point 150 may include a neighborhood information component 152. In one example implementation, the neighborhood information component 152 may instruct at least the access terminal 170 to send at least one measurement report. The neighborhood information component 152 may also instruct other access terminals (not shown in FIG. 1D) to send at least one measurement report. In one example, the access point 150 may receive a measurement report including a plurality of cell identifiers for the neighboring cell A 160a and the neighboring cell B 160b. In another example, the access point 150 may receive a first measurement report including a cell identifier for the neighboring cell A 160a and a second measurement report, within a time window, including an identifier for the neighboring cell B 160b. The time window may be determined by the access point 150 or may be received from a network controller such as an OAM entity. In a second example implementation, the neighborhood information component 152 may perform an NL operation on at least one frequency.

The access point 150 may include a neighborhood determination component 154. For example, the neighborhood determination component 154 may determine that the neighboring cell A 160a and the neighboring cell B 160b are neighbors of each other, in response to receiving a measurement report including the identifiers for the neighboring cell A 160a and the neighboring cell B 160b. As another example, the neighborhood determination component 154 may determine that the neighboring cell A 160a and the neighboring cell B 160b are neighbors of each other, in response to receiving a first measurement report including a cell identifier for the neighboring cell A 160a and a second measurement report including an identifier for the neighboring cell B 160b within a time window. As a further example, the neighborhood determination component 154 may discover from a NL operation that the neighboring cell A 160a and the neighboring cell B 160b are neighbors of each other.

The access point 150 may include a reporting component 156. The reporting component 156 may inform at least one of the neighboring cells 160a or 160b that they are neighbors of each other. In one implementation, the reporting component 156 may send a backhaul message to a neighboring cell. The backhaul message, for example, may be an X2 message. In a second implementation, the reporting component 156 may send a message to a network controller such as an OAM entity, which then informs at least one of the neighboring cells 160a or 160b that they are neighbors of each other.

In an example implementation, the network controller 180 may determine the default power parameter optimized for a hypothetical scenario where a access point and a neighboring cell have equal cell sizes. In one implementation, the network controller 180 may determine an offset value based on a number of uplink receiving antennas of the neighboring cell 160. A cell equipped with more uplink receiving antennas may be able to better withstand interference from mobile devices such as the access terminal 170.

The access point 150 may include a neighborhood relation table 158 on a non-transitory computer-readable medium. The access point 150 may store identifiers for any determined neighboring cells to the neighborhood relation table 158.

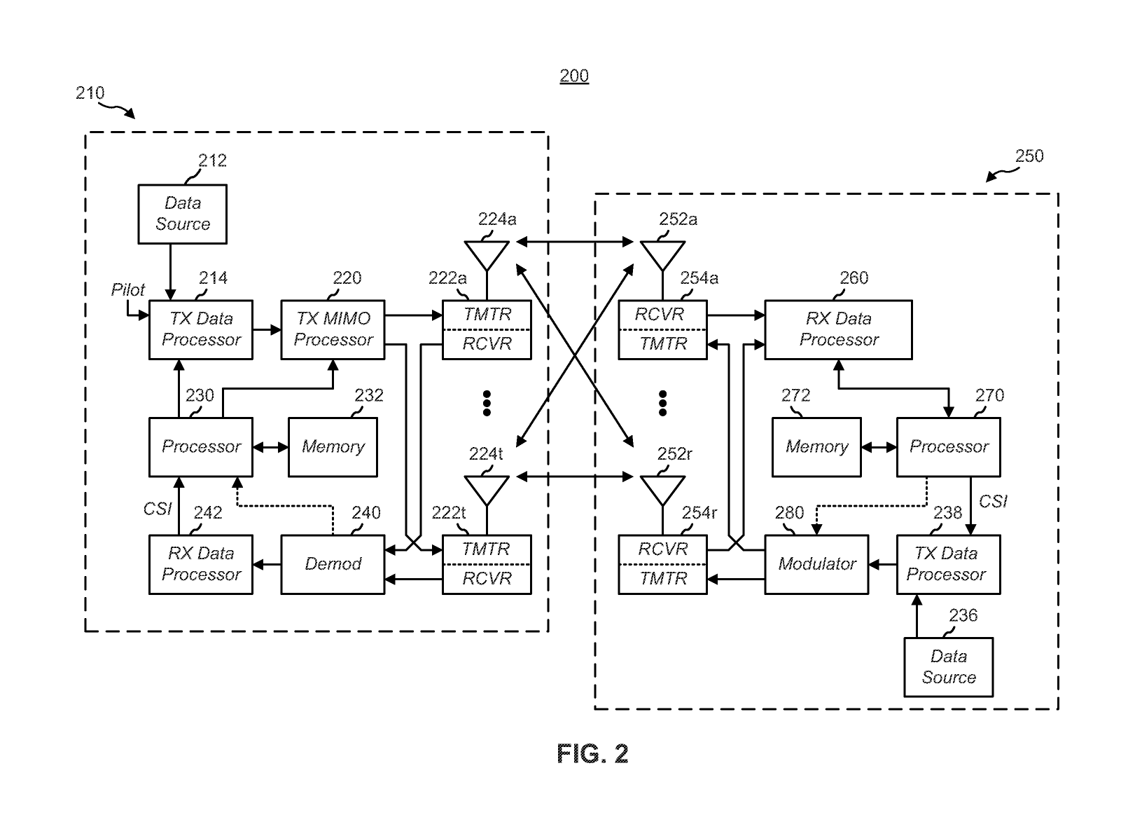

FIG. 2 illustrates a system 200 including a transmitter system 210 (also known as the access point, base station, or eNB) and a receiver system 250 (also known as access terminal, mobile device, or UE) in an LTE MIMO system 200. In the present disclosure, the transmitter system 210 may correspond to a WS-enabled eNB or the like, whereas the receiver system 250 may correspond to a WS-enabled UE or the like.

At the transmitter system 210, traffic data for a number of data streams is provided from a data source 212 to a transmit (TX) data processor 214. Each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain examples, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

As used herein, an access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio access point, a basic service set (BSS), an extended service set (ESS), a macrocell, a macro node, a Home eNB (HeNB), a small cell, a femtocell, a femto node, a pico node, or some other similar terminology.

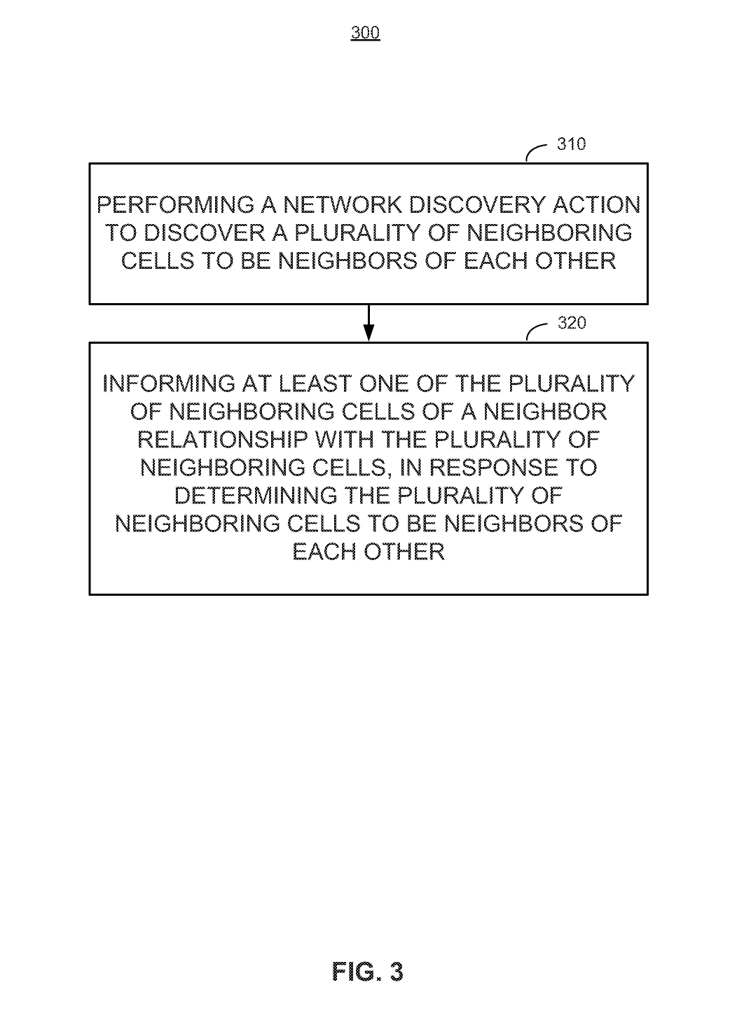

In accordance with one or more aspects of the examples described herein, with reference to FIG. 3, there is shown a methodology 300 for distributed neighboring cell assisted neighbor discovery. The method may be operable, such as, for example, by the access point 110, as shown in FIG. 1B, or the like.

The method 300 may involve, at 310 performing a network discovery action to discover a plurality of neighboring cells to be neighbors of each other.

In a related aspect, performing the network discovery action may include instructing at least one access terminal to send at least one measurement report. Performing the network discovery action may also include determining the plurality of neighboring cells to be neighbors of each other, in response to receiving at least one of: a single measurement report from an access terminal that contains identifiers for the plurality of neighboring cells, or a plurality of measurement reports from the access terminal within a time window that contain identifiers for the plurality of neighboring cells. In an example implementation, the time window is received from an OAM entity.

In a second related aspect, performing the network discovery action may include performing a NL operation on at least one frequency, and determining that the plurality of neighboring cells to be neighbors of each other, based on the NL operation. In a further related aspect, the network entity may add the plurality of neighboring cells into a NRT.

The method 300 may involve, at 320, informing at least one of the plurality of neighboring cells (e.g., neighboring cell A and neighboring cell B of FIG. 1B) of a neighbor relationship with the plurality of neighboring cells, in response to determining the plurality of neighboring cells to be neighbors of each other.

In a related aspect, informing may include sending a backhaul message to at least one of the plurality of neighboring cells. For example, the backhaul message may be an X2 message.

In another related aspect, informing may include sending a message to an OAM entity reporting that the plurality of neighboring cells are neighbors of each other, enabling the OAM to inform the at least one of the plurality of neighboring cells.

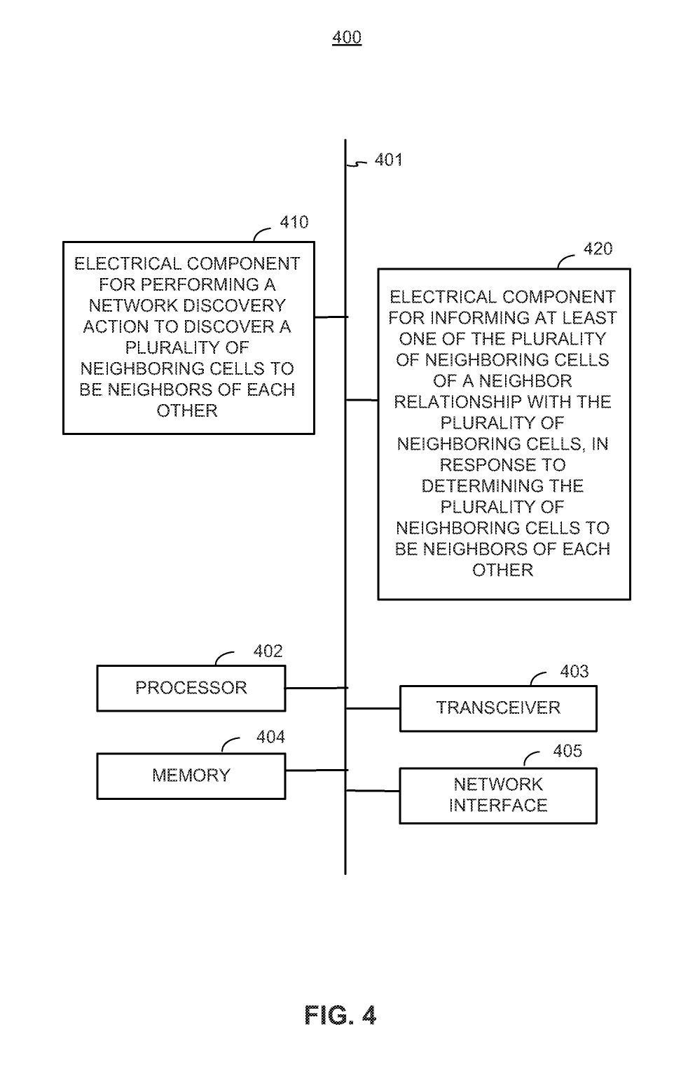

In accordance with one or more aspects of the examples described herein, FIG. 4 shows an example of an apparatus for distributed neighboring cell assisted neighbor discovery, in accordance with the methodology of FIG. 3. The exemplary apparatus 400 may be configured as a computing device or as a processor or similar device/component for use within. In one example, the apparatus 400 may include functional blocks that can represent functions implemented by a processor, software, or combination thereof (e.g., firmware). In another example, the apparatus 400 may be a system on a chip (SoC) or similar integrated circuit (IC).

In one example, apparatus 400 may include an electrical component or module 410 for performing a network discovery action to discover a plurality of neighboring cells to be neighbors of each other.

The apparatus 400 may include an electrical component 420 for informing at least one of the plurality of neighboring cells (e.g., neighboring cell A and neighboring cell B of FIG. 1B) of a neighbor relationship with the plurality of neighboring cells, in response to determining the plurality of neighboring cells to be neighbors of each other.

In further related aspects, the apparatus 400 may optionally include a processor component 402. The processor 402 may be in operative communication with the components 410-420 via a bus 401 or similar communication coupling. The processor 402 may effect initiation and scheduling of the processes or functions performed by electrical components 410-420.

In yet further related aspects, the apparatus 400 may include a radio transceiver component 403. A standalone receiver and/or standalone transmitter may be used in lieu of or in conjunction with the transceiver 403. The apparatus 400 may also include a network interface 405 for connecting to one or more other communication devices or the like. The apparatus 400 may optionally include a component for storing information, such as, for example, a memory device/component 404. The computer readable medium or the memory component 404 may be operatively coupled to the other components of the apparatus 400 via the bus 401 or the like. The memory component 404 may be adapted to store computer readable instructions and data for affecting the processes and behavior of the components 410-420, and subcomponents thereof, or the processor 402, or the methods disclosed herein. The memory component 404 may retain instructions for executing functions associated with the components 410-420. While shown as being external to the memory 404, it is to be understood that the components 410-420 can exist within the memory 404. It is further noted that the components in FIG. 4 may comprise processors, electronic devices, hardware devices, electronic sub-components, logical circuits, memories, software codes, firmware codes, etc., or any combination thereof. Persons skilled in the art will appreciate that the functionalities of each component of apparatus 400 can be implemented in any suitable component of the system or combined in any suitable manner.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein, but is to be accorded the widest scope consistent with the principles and novel features disclosed herein.

1. A method of wireless communication, operable by a network entity, comprising:
performing a network discovery action to discover a plurality of neighboring cells to be neighbors of each other; and
informing at least one of the plurality of neighboring cells of a neighbor relationship with the plurality of neighboring cells, in response to determining the plurality of neighboring cells to be neighbors of each other.

2. The method of claim 1, wherein performing the network discovery action comprises:
instructing at least one access terminal to send at least one measurement report; and
determining the plurality of neighboring cells to be neighbors of each other, in response to receiving at least one of:
a single measurement report from an access terminal that contains identifiers for the plurality of neighboring cells; or
a plurality of measurement reports from the access terminal within a time window that contain identifiers for the plurality of neighboring cells.

3. The method of claim 2, wherein the time window is received from an operations administration and management (OAM) entity.

4. The method of claim 1, wherein performing the network discovery action comprises:
performing a network listen (NL) operation on at least one frequency; and
determining that the plurality of neighboring cells to be neighbors of each other, based on the NL operation.

5. The method of claim 4, further comprising adding the plurality of neighboring cells into a neighbor relation table (NRT).

6. The method of claim 1, wherein informing comprises sending a backhaul message to at least one of the plurality of neighboring cells.

7. The method of claim 4, wherein the backhaul message is an X2 message.

8. The method of claim 1, wherein informing comprises sending a message to an operations administration and management (OAM) entity reporting that the plurality of neighboring cells are neighbors of each other, enabling the OAM to inform the at least one of the plurality of neighboring cells.

9. The method of claim 1, wherein the network entity is an access point.

10. A wireless communication apparatus, comprising:
at least one processor configured to:
perform a network discovery action to discover a plurality of neighboring cells to be neighbors of each other; and
inform at least one of the plurality of neighboring cells of a neighbor relationship with the plurality of neighboring cells, in response to determining the plurality of neighboring cells to be neighbors of each other.

11. The apparatus of claim 10, wherein performing the network discovery action comprises:
instructing at least one access terminal to send at least one measurement report; and
determining the plurality of neighboring cells to be neighbors of each other, in response to receiving at least one of:
a single measurement report from an access terminal that contains identifiers for the plurality of neighboring cells; or
a plurality of measurement reports from the access terminal within a time window that contain identifiers for the plurality of neighboring cells.

12. The apparatus of claim 11, wherein the time window is received from an operations administration and management (OAM) entity.

13. The apparatus of claim 10, wherein performing the network discovery action comprises:
performing a network listen (NL) operation on at least one frequency; and
determining that the plurality of neighboring cells to be neighbors of each other, based on the NL operation.

14. The apparatus of claim 13, further comprising adding the plurality of neighboring cells into a neighbor relation table (NRT).

15. The apparatus of claim 10, wherein informing comprises sending a backhaul message to at least one of the plurality of neighboring cells.

16. The apparatus of claim 15, wherein the backhaul message is an X2 message.

17. The apparatus of claim 10, wherein informing comprises sending a message to an operations administration and management (OAM) entity reporting that the plurality of neighboring cells are neighbors of each other, enabling the OAM to inform the at least one of the plurality of neighboring cells.

18. The apparatus of claim 10, wherein the network entity is an access point.

19. A computer program product, comprising:
a non-transitory computer-readable medium comprising:
code for performing a network discovery action to discover a plurality of neighboring cells to be neighbors of each other; and
code for informing at least one of the plurality of neighboring cells of a neighbor relationship with the plurality of neighboring cells, in response to determining the plurality of neighboring cells to be neighbors of each other.

20. The computer program product of 19, wherein the code for performing the network discovery action comprises:
code for instructing at least one access terminal to send at least one measurement report; and
code for determining the plurality of neighboring cells to be neighbors of each other, in response to receiving at least one of:
a single measurement report from an access terminal that contains identifiers for the plurality of neighboring cells; or
a plurality of measurement reports from the access terminal within a time window that contain identifiers for the plurality of neighboring cells.

21. The computer program product of 20, wherein the time window is received from an operations administration and management (OAM) entity.

22. The computer program product of 19, wherein code for performing the network discovery action comprises:
code for performing a network listen (NL) operation on at least one frequency; and
code for determining that the plurality of neighboring cells to be neighbors of each other, based on the NL operation.

23. The computer program product of 19, further comprising code for adding the plurality of neighboring cells into a neighbor relation table (NRT).

24. The computer program product of 19, wherein code for informing comprises code for sending a backhaul message to at least one of the plurality of neighboring cells.

25. The computer program product of 24, wherein the backhaul message is an X2 message.

26. The computer program product of 19, wherein code for informing comprises code for sending a message to an operations administration and management (OAM) entity reporting that the plurality of neighboring cells are neighbors of each other, enabling the OAM to inform the at least one of the plurality of neighboring cells.

27. The computer program product of 19, wherein the network entity is an access point.

28. A wireless communication apparatus, comprising:
means for performing a network discovery action to discover a plurality of neighboring cells to be neighbors of each other; and
means for informing at least one of the plurality of neighboring cells of a neighbor relationship with the plurality of neighboring cells, in response to determining the plurality of neighboring cells to be neighbors of each other.

29. The apparatus of claim 28, wherein means for performing the network discovery action comprises:
means for instructing at least one access terminal to send at least one measurement report; and
means for determining the plurality of neighboring cells to be neighbors of each other, in response to receiving at least one of:
a single measurement report from an access terminal that contains identifiers for the plurality of neighboring cells; or
a plurality of measurement reports from the access terminal within a time window that contain identifiers for the plurality of neighboring cells.

30. The apparatus of claim 28, wherein means for performing the network discovery action comprises:
means for performing a network listen (NL) operation on at least one frequency; and
means for determining that the plurality of neighboring cells to be neighbors of each other, based on the NL operation.
